(19) United States
(12) Patent Application Publication
(10) Pub. No.: US 2017/0132521 A1
(43) Pub. Date: May 11, 2017

(54) DRIVING BEHAVIOR EVALUATING METHOD AND DEVICE

(71) Applicant: Leauto Intelligent Technology (BEIJING) Co. Ltd., Beijing (CN)

(72) Inventors: Yong XU, Beijing (CN); Kunsheng CHEN, Beijing (CN); Wenrui LI, Beijing (CN); Peng LIU, Beijing (CN); Dan LI, Beijing (CN); Yu ZOU, Beijing (CN); Wei LIN, Beijing (CN)

(21) Appl. No.: 14/970,279

(22) Filed: Dec. 15, 2015

(30) Foreign Application Priority Data
Nov. 6, 2015 (CN) 201510753643.8

(51) Int. Cl. G06N 5/04; B60W 40/08

(52) U.S. Cl. CPC G06N 5/046; B60W 40/08; B60W 2040/0827; B60W 2040/0836

(57) ABSTRACT

Embodiments of the present disclosure provide a driving behavior evaluating method and device. The method specifically includes: according to an acquired driving data information, determining a driving behavior corresponding to the driving data information; and sending a prompt information when determining that the driving behavior is a dangerous driving behavior. According to the embodiments of the present disclosure, the prompt information is sent when the driving behavior is determined to be a dangerous driving behavior, so that traffic accidents are avoided.

### CROSS-REFERENCE TO RELATED APPLICATIONS

This application claims the priority to Chinese Patent Application No. 201510753643.8, filed with the State Intellectual Property Office of People's Republic of China on Nov. 6, 2015 and entitled “driving behavior evaluating method and device”, the content of which is hereby incorporated by reference in its entirety.

### FIELD OF TECHNOLOGY

The present disclosure relates to the technical field of Internet of Vehicles, and particularly relates to a driving behavior evaluating method and device.

### BACKGROUND

With continuous development of social economy and continuous improvement of people's living standard, automobiles have become indispensable transport means in people's life. However, the driving skills of drivers are different, so many unsafe or unreasonable operation behaviors exist during driving of vehicles, and are likely to cause traffic accidents.

In existing solutions, in order to reduce traffic accidents, transport enterprises need to install satellite positioning devices conforming to Technical Requirements for Vehicle Terminals of Satellite Positioning Systems of Road Transport Vehicles (JT/T794-2011) for “two kinds of passenger service vehicles and one kind of hazardous articles transport vehicles” according to the requirements of Notification of the State Council about Further Strengthening Enterprise Safety Production, and connect the satellite positioning devices to a national major operation vehicle network joint control system, to ensure that vehicle monitoring data is accurately and completely transmitted in real time and ensure that the vehicle-mounted satellite positioning devices work normally and are accurate in data and valid in monitoring.

However, the above-mentioned satellite positioning devices can merely acquire such information as driver identity information, vehicular-road video, in-vehicle audio, vehicle position and the like, but still cannot effectively reduce the quantity of traffic accidents.

### SUMMARY

Embodiments of the present disclosure provide a driving behavior evaluating method and device, for solving the problem that traffic accidents cannot be effectively reduced in the prior art, and avoiding traffic accidents by sending prompt information when determining that the driving behavior is a dangerous driving behavior.

An embodiment of the present disclosure provides a driving behavior evaluating method, including:

according to an acquired driving data information, determining a driving behavior corresponding to the driving data information; and

sending a prompt information when determining that the driving behavior is a dangerous driving behavior.

An embodiment of the present disclosure provides a driving behavior evaluating device, including:

one or more processor; and

a memory, wherein:

one or more computer readable program codes are stored in the memory, and the one or more processors are configured to perform the one or more computer readable program codes to perform:

according to an acquired driving data information, determining a driving behavior corresponding to the driving data information; and

sending a prompt information when determining that the driving behavior is a dangerous driving behavior.

In the driving behavior evaluating method and device provided by the embodiments of the present disclosure, the driving behavior corresponding to the driving data information is determined according to the acquired driving data information, and then the prompt information is sent when the driving behavior is determined to be a dangerous driving behavior, so compared with the prior art, the embodiments of the present disclosure can discover dangerous driving behaviors in time during running of vehicles, then measures can be taken in time to avoid traffic accidents, and traffic accidents can be effectively reduced.

### BRIEF DESCRIPTION OF THE DRAWINGS

In order to describe the technical solutions in the embodiments of the present disclosure or in the prior art more clearly, a simple introduction to the accompanying drawings which are needed in the description of the embodiments or the prior art is given below. Apparently, the accompanying drawings in the description below are merely some of the embodiments of the present disclosure, based on which other drawings may be obtained by those of ordinary skill in the art without any creative effort.

FIG. 1 shows an operation flow diagram of embodiment 1 of a driving behavior evaluating method of the present disclosure;

FIG. 2 shows an operation flow diagram of embodiment 2 of a driving behavior evaluating method of the present disclosure;

FIG. 3 shows a structural schematic diagram of a driving behavior evaluating system of the present disclosure; and

FIG. 4 shows a structural block diagram of a driving behavior evaluating device embodiment of the present disclosure;

FIG. 5 shows a structural block diagram of a driving behavior evaluating device embodiment of the present disclosure.

### DESCRIPTION OF THE EMBODIMENTS

To make the objectives, technical solutions and advantages of the embodiments of the present disclosure clearer, a clear and complete description of the technical solutions in the present disclosure will be given below, in conjunction with the accompanying drawings in the embodiments of the present disclosure. Apparently, the embodiments described below are a part, but not all, of the embodiments of the present disclosure. All of other embodiments, obtained by those of ordinary skill in the art based on the embodiments of the present disclosure without any creative effort, fall into the protection scope of the present disclosure.

### Embodiment 1

Refer to FIG. 1, which shows an operation flow diagram of embodiment 1 of a driving behavior evaluating method of the present disclosure. The method specifically may include the following operations:

Operation 101, according to an acquired driving data information, a driving behavior corresponding to the driving data information is determined.

In the embodiment of the present disclosure, a vehicle ignition process can be regarded as a new driving behavior start mark. Thus, the process from vehicle ignition to vehicle flameout can be regarded as a minimum unit for driving behavior evaluation, the driving behavior evaluating method of the present disclosure is executed when a vehicle is ignited, and the evaluation ends when the vehicle is flamed out. Of course, in practical application, those skilled in the art can select the timing of driving behavior evaluation according to requirements, e.g. evaluation is carried out between a certain start and stop of a vehicle, etc., and the specific timing of driving behavior evaluation is not limited in the present disclosure.

According to the embodiment of the present disclosure, the driving data information may be acquired during running of a vehicle, wherein the driving data information specifically may include speed information, driver face information, in-vehicle air alcohol content information, lane changing time interval information, acceleration information, etc. In practical application, those skilled in the art can acquire the driving data information according to requirements, and the present disclosure does not limit the category of the acquired driving data information or the acquiring method. After the driving data information is acquired, the driving behavior corresponding to the driving data information can be determined by analyzing the driving data information. Once the driving behavior is discovered to be dangerous, a prompt information can be sent to avoid traffic accidents.

Operation 102, a prompt information is sent when determining that the driving behavior is a dangerous driving behavior.

In the embodiment of the present disclosure, the dangerous driving behavior may include at least one of the following behaviors: overspeed behavior, drunken driving behavior, frequent lane changing behavior, sharp acceleration/deceleration behavior and fatigue driving behavior.

The embodiment of the present disclosure may provide the following technical solutions for determining that the driving behavior is a dangerous one:

Technical Solution 1

In the technical solution 1, the driving data information specifically may include a speed information; and the operation of determining that the driving behavior is an overspeed behavior specifically may include:

determining that the corresponding driving behavior is the overspeed behavior when the speed information is greater than a current road speed limiting information.

In specific application, speed information of a vehicle may be determined by monitoring and analyzing a message sent from a vehicular ABS (antilock brake system) sensor to an instrument panel, and is combined with vehicle position information acquired by a positioning system to determine speed limiting information of a road where the current position of the vehicle is; and whether the vehicle is overspeed may be determined by comparing the speed information with the speed limiting information.

Technical Solution 2

In the technical solution 2, the driving data information specifically may include a driver face information; and the operation of determining that the driving behavior is a fatigue driving behavior specifically may include:

determining that the corresponding driving behavior is the fatigue driving behavior when a frequency of a fatigue expression appearing in the face information is greater than a preset frequency, wherein the fatigue expression includes at least one of the following face expressions: blinking, nodding, head shaking, head drop and yawn.

In specific application, the driver face information may be shot by a driver face camera, a driver having the expression of frequent blinking, nodding, head shaking, head drop, yawn and the like is judged through face recognition, for example, the fatigue expression appears for more than three times within one minute, and then it can be determined that the driver is in fatigue driving. It could be understood that the present disclosure does not limit the category of the fatigue expression or the magnitude of the preset frequency.

Technical Solution 3

In the technical solution 3, the driving data information specifically may include an in-vehicle air alcohol content information; and the operation of determining that the driving behavior is a drunken driving behavior specifically may include: determining that the corresponding driving behavior is the drunken driving behavior when the in-vehicle air alcohol content information is greater than a first threshold.

The first threshold is a lowest percent of in-vehicle air alcohol content under the condition that driver drinking can be detected. Of course, the present disclosure does not limit the specific magnitude of the first threshold. In practical application, since the function of detecting drunken driving may have certain error, for example, the alcohol exhaled by a passenger may result in that the in-vehicle air alcohol content is greater than the first threshold, and thus a drunken driving behavior is misjudged, so in the embodiment of the present disclosure, drunken driving may be judged according to the following two rules: firstly, detecting that the in-vehicle air alcohol content information being greater than the first threshold; and secondly, detecting fatigue driving of a driver by the driver face camera. Because a drunk driver is generally in a fatigue state, the accuracy of judging the drunken driving behavior can be improved through the above two operations. Of course, under the condition that the driver is judged in drunken driving, even if it is misjudgment, it at least indicates that the in-vehicle air alcohol content has exceeded the first threshold; and because the alcohol exhaled by the passenger may bring strong stimulus and interference to an alcohol-sensitive driver to cause an accident, it may also be regarded as a dangerous driving behavior.

Technical Solution 4

In the technical solution 4, the driving data information specifically may include a lane changing time interval information; and the operation of determining that the driving behavior is a frequent lane changing behavior specifically may include:

determining that the corresponding driving behavior is the frequent lane changing behavior when the lane changing time interval information is smaller than a second threshold.

In specific application, the road condition in front of a vehicle may be shot by a front road camera, and whether the vehicle frequently changes the lane is determined under the coordination of an angular speed sensor, for example, if the time interval information between every two times of lane change is smaller than the second threshold, e.g. 5 minutes, a frequent lane changing behavior is determined. It could be understood that the present disclosure does not limit the specific magnitude of the second threshold.

Technical Solution 5

In the technical solution 5, the driving data information specifically may include an acceleration information; and

the operation of determining that the driving behavior is a sharp acceleration/deceleration behavior specifically may include:

determining that the corresponding driving behavior is the sharp acceleration/deceleration behavior when the acceleration information during a running of a vehicle and/or a brake is greater than a third threshold.

In specific application, the acceleration information of a vehicle may be recorded by acceleration and angular speed sensors, and the behavior that the running acceleration or the braking acceleration is greater than 0.1 times gravitational acceleration may be judged as a driving behavior of deeply stepping on an accelerator (sharp acceleration) or deeply stepping on a brake (sharp deceleration), each of which belongs to a dangerous driving behavior. It could be understood that the third threshold being 0.1 times gravitational acceleration is merely an application example of the present disclosure, and the present disclosure does not limit the specific magnitude of the third threshold.

In practical application, during running of a vehicle, the driving behavior of the driver can be evaluated, and once the driving behavior accords with one of the above-mentioned dangerous driving behaviors, prompt information can be sent to the driver to correct the dangerous driving behavior of the driver and avoid accidents. It could be understood that the five dangerous driving behaviors listed above are merely application examples of the present disclosure, other kinds of dangerous driving behaviors can be set in practical application, and the present disclosure does not limit the specific form of the dangerous driving behavior. Moreover, if a serious dangerous driving behavior such as drunken driving or overspeed is discovered on a smart road, neighboring vehicles and a check vehicle operating in a road network may be notified through the V2X (Vehicle to X) function of the smart road, to prompt the neighboring vehicles to pay attention to a danger, and notify the check vehicle to position and chase the dangerous running vehicle in real time. V2X is a novel vehicle-road and vehicle-vehicle communication technology, has the characteristics of simple connection, low network delay and the like, is applicable to data transmission of traffic information and emergent information, and does not depend on a mobile communication network so as to solve the problem of instable signals and save the traffic cost. Through the embodiment of the present disclosure, dangerous driving behaviors on a road can be discovered in time, so that measures can be taken in time to avoid traffic accidents.

In conclusion, the driving behavior corresponding to the driving data information is determined according to the acquired driving data information, and then the prompt information is sent when the driving behavior is determined to be a dangerous driving behavior, so compared with the prior art, the embodiment of the present disclosure can discover dangerous driving behaviors in time during running of vehicles, then measures can be taken in time to avoid traffic accidents, and traffic accidents can be effectively reduced.

### Embodiment 2

On the basis of embodiment 1, this embodiment may further include the following optional technical solutions. In this embodiment, during the driving behavior evaluation, a driving behavior evaluation table may be further generated, so that road and vehicle operation departments and the traffic safety management department dynamically master the driving behaviors of drivers through the driving behavior evaluation table, to timely discover and reduce potential road safety hazards.

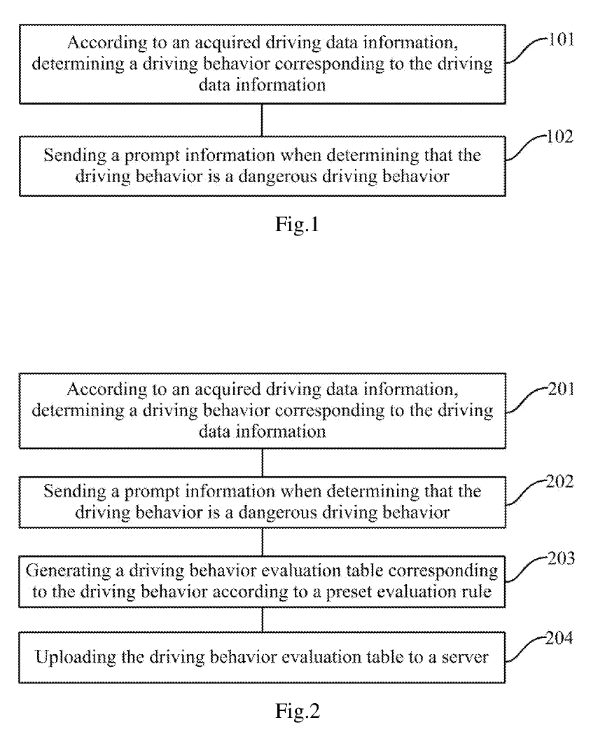

See FIG. 2, which shows a operation flow diagram of embodiment 2 of a driving behavior evaluating method of the present disclosure. The method specifically may include the following operations:

201, according to the acquired driving data information, determining a driving behavior corresponding to the driving data information;

202, sending the prompt information when determining that the driving behavior is a dangerous driving behavior; and

203, generating a driving behavior evaluation table corresponding to the driving behavior according to a preset evaluation rule.

In a preferred embodiment of the present disclosure, the operation of generating a driving behavior evaluation table corresponding to the driving behavior according to a preset evaluation rule specifically may include:

S11, initializing a driving behavior evaluation table, and setting a initial evaluation value of evaluation item in the driving behavior evaluation table, wherein the driving behavior evaluation table includes the evaluation item and the evaluation value corresponding to the evaluation item; and

S12, when determining that the driving behavior is a dangerous driving behavior, updating the initial evaluation value of the evaluation item corresponding to the driving behavior according to a preset evaluation rule to obtain an updated driving behavior evaluation table.

In an application example of the present disclosure, after a vehicle is ignited and started, the driving behavior evaluation table can be initiated, the initial evaluation values of the evaluation items in the driving behavior evaluation table are set, for example, the initial evaluation value corresponding to each evaluation item is set to be a full score, thus the comprehensive evaluation value of the driving behavior evaluation table is full score, for example 100 scores; and then the evaluation items in the driving behavior evaluation table are evaluated one by one, for example, when the driving behavior is determined to be a dangerous driving behavior, the initial evaluation value of the evaluation item corresponding to the driving behavior is updated according to a preset evaluation rule to obtain an updated driving behavior evaluation table.

In a preferred embodiment of the present disclosure, the preset evaluation rule may be a deduction rule.

The operation of when determining that the driving behavior is a dangerous driving behavior, updating the initial evaluation values of the evaluation items corresponding to the driving behavior according to a preset evaluation rule to obtain an updated driving behavior evaluation table, specifically may include:

when determining that the driving behavior is a dangerous driving behavior, deducting corresponding scores from the corresponding evaluation items in the driving behavior evaluation table according to a preset deduction rule to obtain a deducted driving behavior evaluation table. The safety of the driving behavior can be intuitively evaluated by adopting a deduction-based evaluating method, for example, the initial comprehensive evaluation value is 100 scores, the comprehensive evaluation value finally obtained after the evaluation items are evaluated and deducted by the corresponding scores is 60 scores, and the driving behavior has more risks if the final comprehensive evaluation value is low.

It could be understood that the above process of updating the initial evaluation values of the evaluation items corresponding to the driving behavior according to the preset deduction rule is merely exemplary, and in practice, those skilled in the art may further adopt a preset addition rule according to the actual application demand to update the initial evaluation values of the evaluation items corresponding to the driving behavior. For example, the initial comprehensive evaluation value is 0 score, each evaluation item is evaluated according to an addition rule and added with a corresponding score, the driving behavior has more risks if the final comprehensive evaluation value is high, and the present disclosure does not limit the specific evaluation rule. The evaluation items may be adjusted according to a periodic traffic accident investigation report, the specific plus rule may be obtained by evaluating the acquired driving behavior evaluation table, and the evaluation items and the plus rule may be periodically adjusted and continuously optimized. In practical application, those skilled in the art could flexibly set the category and the number of the evaluation items, and the present disclosure does not limit the category of the evaluation items.

In an application example of the present disclosure, after a vehicle is ignited, the initial comprehensive evaluation value of the driving behavior evaluation table is 100 scores; during running of the vehicle, the evaluation items in the driving behavior evaluation table are evaluated one by one, for example, when an overspeed driving behavior is determined, corresponding scores are deducted from the corresponding evaluation items according to a preset deduction rule; it is supposed that 10 scores are deducted for the overspeed driving behavior, 5 scores are deducted from the corresponding evaluation items when the driving behavior is a fatigue driving behavior, etc.; and a deducted driving behavior evaluation table is finally obtained. Refer to table 1, which shows an application example of a driving behavior evaluation table of the present disclosure, including evaluation items and corresponding evaluation values.

TABLE 1

| Number | Evaluation Item | Evaluation Value |
|---|---|---|
| 1 | ignition, initial state | +100 |
| 2 | untied with a safety belt | −10 |
| 3 | alcohol detected | −1 |
| 4 | drunken driving | −10 |
| 5 | sharp acceleration/deceleration | −1 |
| 6 | frequent lane change | −0.5 |
| 7 | non-owner driving | −1 |
| 8 | fatigue driving | −5 |
| 9 | driving on a rugged road | −1 |
| 10 | collision | −10 |
| 11 | overspeed | −10 |
| . . . | . . . | . . . |

Operation 204, uploading the driving behavior evaluation table to a server.

The embodiment of the present disclosure may be applied to a smart road, and the driving behavior evaluation table and/or the acquired driving data information are uploaded to the server through V2X (Vehicle to X) technology. It could be understood that the embodiment of the present disclosure may also be applied to a common road, the driving behavior evaluation table and/or the acquired driving data information are uploaded to the server through a mobile communication network, and the present disclosure does not limit the specific communication mode between the vehicle and the server.

According to the embodiment of the present disclosure, the generated driving behavior evaluation table is uploaded to the server, so that road and vehicle operation departments and the traffic safety management department can dynamically master the driving behaviors of drivers, to timely discover and reduce potential road safety hazards. After accumulating a large amount of driving safety data and accident analysis cases, the data operation department can extract the driving behavior evaluation rule more suitable for the national condition, to cultivate good driving behaviors of drivers and then reduce traffic accidents.

### Embodiment 3

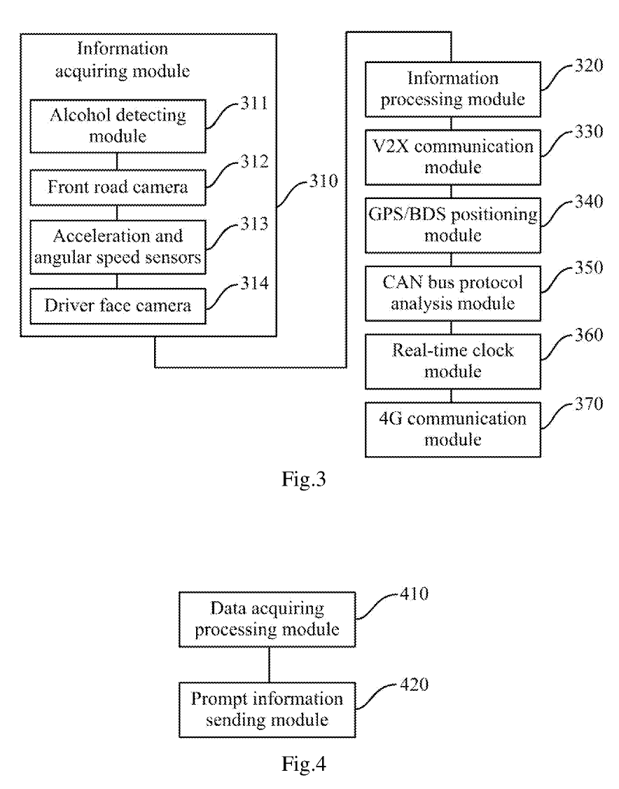

Refer to FIG. 3, which shows a structural schematic diagram of a driving behavior evaluating system of the present disclosure. The system specifically may include the following modules: an information acquiring module 310, an information processing module 320 and a V2X communication module 330.

The information acquiring module 310 is configured for acquiring driving data information, and the information acquiring module 310 specifically may include:

an alcohol detecting module 311, configured for monitoring the alcohol content of in-vehicle air, and cooperates with the driver face camera to recognize whether a driver is in drunken driving. With respect to a drunken driving behavior, the corresponding evaluation item in the driving behavior evaluation table is deducted by 10 scores, and “suspected drunken driving” is noted in the remark column.

a front road camera 312, configured for recording the road condition in front of a vehicle, and cooperates with the acceleration sensor to record images and sound in front of the vehicle during vehicle collision and sharp braking. The camera may further cooperate with the angular speed sensor to analyze whether the vehicle frequently changes the lane, for example, if the time interval between every two times of lane change is less than 5 minutes, a frequent lane change driving behavior is determined, and the corresponding evaluation item in the driving behavior evaluation table is deducted by 0.5 score. Generally, a vehicle changing the lane frequently may further be regarded as a vehicle having potential collision hazard.

an acceleration and angular speed sensors 313, configured for recording sharp acceleration and sharp deceleration information of a vehicle, the behavior that the running acceleration or the braking acceleration is greater than 0.1 times gravitational acceleration may be judged as a driving behavior of deeply stepping on an accelerator (sharp acceleration) or deeply stepping on a brake (sharp deceleration), each of which belongs to a dangerous driving behavior, and the corresponding evaluation item in the driving behavior evaluation table is deducted by 1 score. Moreover, the acceleration and angular speed sensors are further used as navigation aided devices, and can be used for inferring the speed and the position of a vehicle when satellite positioning signals are unavailable.

a driver face camera 314, configured for judging the identity information of a current driver through a face recognition technology and a biological method and judging whether the current driver is in a fatigue driving behavior by recognizing the states of blinking, nodding, head shaking, head drop, eye closure, yawn and the like, and if the driving behavior is a fatigue driving behavior, the corresponding evaluation item in the driving behavior evaluation table is deducted by 5 scores. Meanwhile, if the alcohol content of the in-vehicle air exceeds the preset threshold, a drunken driving behavior can be judged. Moreover, the driver face camera may also be used for judging whether the driver is in an anger state, and this may also be used for evaluating a dangerous driving behavior.

It could be understood that the category of the information acquired by the information acquiring module is merely an application example of the present disclosure, and the present disclosure does not limit the category and the quantity of the information acquired by the information acquiring module.

an information processing module 320, configured for analyzing the driving data information acquired by each sensor, maintaining the driving behavior evaluation table, and uploading the acquired driving data information and/or the generated driving behavior evaluation table to a server.

a V2X communication module 330, configured for vehicle-road cooperative communication. The communication mode depends on a smart road with V2X function, instead of a mobile communication network.

In a preferred embodiment of the present disclosure, the system may further include:

a GPS (Global Positioning System)/BDS (BeiDou Navigation Satellite System) positioning module 340 for positioning the specific position of a vehicle. Under the complex road condition of China, the performance of a BeiDou receiver on part of occasions is superior to that of a GPS receiver. The system adopting double-mode positioning algorithm fusion and two modes in the embodiment of the present disclosure has higher positioning precision.

In another preferred embodiment of the present disclosure, the system may further include:

a CAN (Controller Area Network) bus protocol analysis module 350 for acquiring data on a vehicular CAN bus, and determining the current running state of a vehicle by data analysis.

In a further embodiment of the present disclosure, the system may further include:

a real-time clock module 360 for generating a real-time clock, and marking time for important events, e.g., start/stop, sharp acceleration/deceleration, sharp turning, collision, fatigue driving, etc.

In a further embodiment of the present disclosure, the system may further include:

a 4G (the 4^{th} Generation mobile communication) communication module 370, configured as a supplementary data channel in the absence of a V2X communication environment.

Application Example

In an application example of the present disclosure, a method for evaluating a driving behavior by adopting the above-mentioned driving behavior evaluating system specifically may include the following operations:

S21, downloading a latest evaluation rule, and initializing a driving behavior evaluation table,

wherein a vehicle is regarded as already entering a running state after being ignited successfully, the V2X communication module communicates with a smart road, the latest evaluation rule including evaluation items and a deduction rule is downloaded, the corresponding score is deducted if a certain evaluation item satisfies the deduction rule during driving, and the comprehensive evaluation value of the current driving behavior may be finally obtained;

S22, according to the acquired driving data information, determining a driving behavior corresponding to the driving data information;

S23, when determining that the driving behavior is a dangerous driving behavior, sending a prompt information; and

S24, when determining that the driving behavior is a dangerous driving behavior, deducting corresponding scores from the corresponding evaluation items in the driving behavior evaluation table according to a preset deduction rule to obtain a deducted driving behavior evaluation table.

In the whole running process, the information processing module may analyze the driving data information in real time, and deduct the corresponding score from the corresponding evaluation item in the driving behavior evaluation table according to a preset deduction rule when the driving behavior corresponding to the driving data information is a dangerous driving behavior. In this application example, the driving behavior evaluation table specifically may include the following evaluation items:

S240: untied with a safety belt,

specifically, a locking signal of a driver safety belt may be acquired by a CAN bus BCM (Body Control Module), and a dangerous driving behavior is determined if the driver is not tied with the safety belt after ignition;

S241: alcohol detected,

the function of detecting drunken driving may have certain error, so a dangerous driving behavior is also determined when the alcohol detecting module detects alcohol, for example, the alcohol exhaled by a passenger may bring strong stimulus and interference to an alcohol-sensitive driver to cause an accident;

S242: drunken driving,

in the embodiment of the present disclosure, the judgment rule of drunken driving may include: firstly, detecting alcohol, and then detecting fatigue driving of a driver by the driver face camera;

S243: sharp acceleration and sharp deceleration,

both sharp acceleration and sharp deceleration behaviors determined by the acceleration sensor can be judged as dangerous driving behaviors;

S244, frequent lane change,

specifically, if the time interval of two times of continuous lane change is less than 1 minute, the current driving behavior is judged as frequent lane change and belongs to a dangerous driving behavior;

S245: non-owner driving,

in practical application, driving by a stranger may also be dangerous, so a dangerous driving behavior is judged when the current driver being not the owner is recognized by the driver face camera;

S246: fatigue driving,

when driver's expressions of frequent blinking, head drop, nodding, yawn and the like are judged by face recognition, the driver is judged in fatigue driving, and it is a dangerous driving behavior;

S247: driving on a rugged road,

the acceleration sensor and the angular speed sensor judge whether the current vehicle runs on an urban road, and a dangerous driving behavior is determined if the current vehicle runs on a rugged road;

S248: collision,

the acceleration sensor may report collision information which shows vehicle collision, and a dangerous driving behavior is determined;

S249: overspeed,

the Can bus analysis module can monitor and analyze a message sent from an ABS (antilock brake system) sensor to an instrument panel, and the message is combined with current vehicle position information acquired by the GPS/BDS to determine the limited speed of the current road and whether the vehicle is overspeed.

S25, uploading the driving behavior evaluation table to a server.

After the vehicle is flamed out, a single driving behavior evaluation is completed, and the evaluation result may be transmitted to the server through V2X or a 4G network.

Device Embodiment

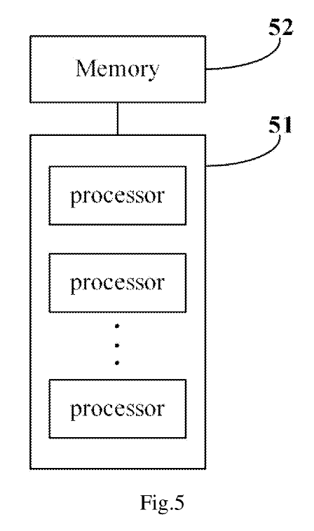

Refer to FIG. 4, which shows a structural block diagram of a driving behavior evaluating device embodiment of the present disclosure. The device specifically may include:

a data acquiring processing module 410 for, according to an acquired driving data information, determining a driving behavior corresponding to the driving data information; and

a prompt information sending module 420 for sending a prompt information when determining that the driving behavior is a dangerous driving behavior.

In a preferred embodiment of the present disclosure, the driving data information specifically may include a speed information; the dangerous driving behavior specifically may include an overspeed behavior;

the device may further include:

an overspeed determining module for determining that the corresponding driving behavior is the overspeed behavior when the speed information is greater than a current road speed limiting information.

In another preferred embodiment of the present disclosure, the driving data information specifically may include an in-vehicle air alcohol content information; the dangerous driving behavior specifically may include a drunken driving behavior;

the device may further include:

a drunken driving determining module for determining that the corresponding driving behavior is the drunken driving behavior when the in-vehicle air alcohol content information is greater than a first threshold.

In a further preferred embodiment of the present disclosure, the driving data information specifically may include a lane changing time interval information; the dangerous driving behavior specifically may include a frequent lane changing behavior;

the device may further include:

a frequent lane change determining module for determining that the corresponding driving behavior is the frequent lane changing behavior when the lane changing time interval information is smaller than a second threshold.

In a further preferred embodiment of the present disclosure, the driving data information specifically may include an acceleration information; the dangerous driving behavior specifically may include a sharp acceleration/deceleration behavior;

the device may further include:

a sharp acceleration/deceleration determining module for determining that the corresponding driving behavior is the sharp acceleration/deceleration behavior when the acceleration information during a running of a vehicle and/or a brake is greater than a third threshold.

In a further preferred embodiment of the present disclosure, the driving data information specifically may include a driver face information; the dangerous driving behavior specifically may include a fatigue driving behavior;

the device may further include:

a fatigue driving determining module for determining that the corresponding driving behavior is the fatigue driving behavior when the frequency of fatigue expression appearing in the face information is greater than a preset frequency, wherein the fatigue expression may include at least one of the following face expressions: blinking, nodding, head shaking, head drop and yawn.

In a further preferred embodiment of the present disclosure, the device may further include:

an evaluation table generating module for generating a driving behavior evaluation table corresponding to the driving behavior according to a preset evaluation rule; and

an uploading module for uploading the driving behavior evaluation table to a server.

In a further preferred embodiment of the present disclosure, the evaluation table generating module specifically may include:

an initialization sub-module for initializing a driving behavior evaluation table, and setting an initial evaluation value of an evaluation item in the driving behavior evaluation table, wherein the driving behavior evaluation table includes the evaluation item and the evaluation value corresponding to the evaluation item; and

an update sub-module for, when determining that the driving behavior is the dangerous driving behavior, updating the initial evaluation value of the evaluation item corresponding to the driving behavior according to a preset evaluation rule to obtain an updated driving behavior evaluation table.

Because the device embodiment is substantially similar to the method embodiment, it is described relatively simply, and for the relevant part, reference may be made to part of the description of the method embodiment.

The relevant functional modules illustrated in FIG. 4 can be embodied as a hardware processor in an embodiment of the disclosure. In a particular implementation, as illustrated in FIG. 5, there is a schematic diagram of a driving behavior evaluating device according to an embodiment of the present disclosure, which can include: one or more processors 51; and a memory 52, wherein: one or more computer readable program codes are stored in the memory, and the one or more processors 51 are configured to perform the one or more computer readable program codes to perform: according to an acquired driving data information, determining a driving behavior corresponding to the driving data information; and

sending a prompt information when determining that the driving behavior is a dangerous driving behavior.

In a preferred embodiment of the present disclosure, the driving data information specifically may include a speed information; the dangerous driving behavior specifically may include an overspeed behavior;

the one or more processors 51 may further configured to perform the one or more computer readable program codes to perform:

determining that the corresponding driving behavior is the overspeed behavior when the speed information is greater than a current road speed limiting information.

In another preferred embodiment of the present disclosure, the driving data information specifically may include an in-vehicle air alcohol content information; the dangerous driving behavior specifically may include a drunken driving behavior;

the one or more processors 51 may further configured to perform the one or more computer readable program codes to perform:

determining that the corresponding driving behavior is the drunken driving behavior when the in-vehicle air alcohol content information is greater than a first threshold.

In a further preferred embodiment of the present disclosure, the driving data information specifically may include a lane changing time interval information; the dangerous driving behavior specifically may include a frequent lane changing behavior;

the one or more processors 51 may further configured to perform the one or more computer readable program codes to perform:

determining that the corresponding driving behavior is the frequent lane changing behavior when the lane changing time interval information is smaller than a second threshold.

In a further preferred embodiment of the present disclosure, the driving data information specifically may include an acceleration information; the dangerous driving behavior specifically may include a sharp acceleration/deceleration behavior;

the one or more processors 51 may further configured to perform the one or more computer readable program codes to perform:

determining that the corresponding driving behavior is the sharp acceleration/deceleration behavior when the acceleration information during a running of a vehicle and/or a brake is greater than a third threshold.

In a further preferred embodiment of the present disclosure, the driving data information specifically may include a driver face information; the dangerous driving behavior specifically may include a fatigue driving behavior;

the one or more processors 51 may further configured to perform the one or more computer readable program codes to perform:

determining that the corresponding driving behavior is the fatigue driving behavior when the frequency of fatigue expression appearing in the face information is greater than a preset frequency, wherein the fatigue expression may include at least one of the following face expressions: blinking, nodding, head shaking, head drop and yawn.

In a further preferred embodiment of the present disclosure, the one or more processors 51 may further configured to perform the one or more computer readable program codes to perform:

generating a driving behavior evaluation table corresponding to the driving behavior according to a preset evaluation rule; and

uploading the driving behavior evaluation table to a server.

In a further preferred embodiment of the present disclosure, the one or more processors 51 may further configured to perform the one or more computer readable program codes to perform:

initializing a driving behavior evaluation table, and setting an initial evaluation value of an evaluation item in the driving behavior evaluation table, wherein the driving behavior evaluation table includes the evaluation item and the evaluation value corresponding to the evaluation item; and

when determining that the driving behavior is the dangerous driving behavior, updating the initial evaluation value of the evaluation item corresponding to the driving behavior according to a preset evaluation rule to obtain an updated driving behavior evaluation table.

The device embodiments described above are merely schematic, wherein the modules illustrated as separate components may be or may not be physically separated, and the components displayed as modules may be or may not be physical modules, that is to say, the components may be positioned at one place or may also be distributed on a plurality of network units. The objectives of the solutions of the embodiments may be achieved by selecting part of or all of the modules according to actual needs. Those of ordinary skill in the art could understand and implement the embodiments without any creative effort.

Through the descriptions of the above embodiments, those skilled in the art could clearly learn that each embodiment may be realized by means of software and a necessary general hardware platform, and of course, may be realized by hardware. Based on such a understanding, the above technical solutions substantially or the part making contribution to the prior art may be embodied in the form of a software product, and the computer software product is stored in a computer readable storage medium, such as an ROM/RAM, a disk, an optical disk and the like, which includes a plurality of instructions enabling computer equipment (which may be a personal computer, a server, or network equipment and the like) to execute the method in each embodiment or at some part of each embodiment.

Finally, it should be noted that the above embodiments are merely used for illustrating rather than limiting the technical solutions of the present disclosure; although the present disclosure is illustrated in detail with reference to the aforementioned embodiments, it should be understood by those of ordinary skill in the art that modifications may still be made on the technical solutions disclosed in the aforementioned respective embodiments, or equivalent substitutions may be made to part of technical characteristics thereof; and these modifications or substitutions shall not make the nature of the corresponding technical solutions depart from the spirit and scope of the technical solutions of the respective embodiments of the present disclosure.

1. A driving behavior evaluating method, comprising:
according to an acquired driving data information, determining a driving behavior corresponding to the driving data information; and
sending a prompt information when determining that the driving behavior is a dangerous driving behavior.

2. The method of claim 1, wherein the driving data information comprises a speed information, and the dangerous driving behavior comprises an overspeed behavior;
determining that the driving behavior is a dangerous driving behavior comprises:
determining that a corresponding driving behavior is the overspeed behavior when the speed information is greater than a current road speed limiting information.

3. The method of claim 1, wherein the driving data information comprises an in-vehicle air alcohol content information, and the dangerous driving behavior comprises a drunken driving behavior;
determining that the driving behavior is a dangerous driving behavior comprises:
determining that a corresponding driving behavior is the drunken driving behavior when the in-vehicle air alcohol content information is greater than a first threshold.

4. The method of claim 1, wherein the driving data information comprises a lane changing time interval information, and the dangerous driving behavior comprises a frequent lane changing behavior;
determining that the driving behavior is a dangerous driving behavior comprises:
determining that a corresponding driving behavior is the frequent lane changing behavior when the lane changing time interval information is smaller than a second threshold.

5. The method of claim 1, wherein the driving data information comprises an acceleration information, and the dangerous driving behavior comprises a sharp acceleration/deceleration behavior;
determining that the driving behavior is a dangerous driving behavior comprises:
determining that a corresponding driving behavior is the sharp acceleration/deceleration behavior when the acceleration information during a running of a vehicle and/or a brake is greater than a third threshold.

6. The method of claim 1, wherein the driving data information comprises a driver face information, and the dangerous driving behavior comprises a fatigue driving behavior;
determining that the driving behavior is a dangerous driving behavior comprises:
determining that a corresponding driving behavior is the fatigue driving behavior when a frequency of a fatigue expression appearing in the face information is greater than a preset frequency, wherein the fatigue expression comprises at least one of the following face expressions: blinking, nodding, head shaking, head drop and yawn.

7. The method of claim 1, further comprising:
generating a driving behavior evaluation table corresponding to the driving behavior according to a preset evaluation rule; and
uploading the driving behavior evaluation table to a server.

8. The method of claim 7, wherein generating a driving behavior evaluation table corresponding to the driving behavior according to a preset evaluation rule comprises:
initializing a driving behavior evaluation table, and setting an initial evaluation value of an evaluation item in the driving behavior evaluation table, wherein the driving behavior evaluation table comprises the evaluation item and the evaluation value corresponding to the evaluation item; and
when determining that the driving behavior is the dangerous driving behavior, updating the initial evaluation value of the evaluation item corresponding to the driving behavior according to a preset evaluation rule to obtain an updated driving behavior evaluation table.

9. A driving behavior evaluating device, comprising:
one or more processor; and
a memory, wherein:
one or more computer readable program codes are stored in the memory, and the one or more processors are configured to perform the one or more computer readable program codes to perform:
according to an acquired driving data information, determining a driving behavior corresponding to the driving data information; and
sending a prompt information when determining that the driving behavior is a dangerous driving behavior.

10. The device of claim 9, wherein the driving data information comprises a speed information, and the dangerous driving behavior comprises an overspeed behavior;
the one or more processors are further configured to perform the one or more computer readable program codes to perform:
determining that a corresponding driving behavior is the overspeed behavior when the speed information is greater than a current road speed limiting information.

11. The device of claim 9, wherein the driving data information comprises an in-vehicle air alcohol content information, and the dangerous driving behavior comprises a drunken driving behavior;
the one or more processors are further configured to perform the one or more computer readable program codes to perform:
determining that a corresponding driving behavior is the drunken driving behavior when the in-vehicle air alcohol content information is greater than a first threshold.

12. The device of claim 9, wherein the driving data information comprises a lane changing time interval information, and the dangerous driving behavior comprises a frequent lane changing behavior;
the one or more processors are further configured to perform the one or more computer readable program codes to perform:
determining that a corresponding driving behavior is the frequent lane changing behavior when the lane changing time interval information is smaller than a second threshold.

13. The device of claim 9, wherein the driving data information comprises an acceleration information, and the dangerous driving behavior comprises a sharp acceleration/deceleration behavior;
the one or more processors are further configured to perform the one or more computer readable program codes to perform:
determining that a corresponding driving behavior is the sharp acceleration/deceleration behavior when the acceleration information during a running of a vehicle and/or a brake is greater than a third threshold.

14. The device of claim 9, wherein the driving data information comprises a driver face information, and the dangerous driving behavior comprises a fatigue driving behavior;
the one or more processors are further configured to perform the one or more computer readable program codes to perform:
determining that a corresponding driving behavior is the fatigue driving behavior when a frequency of a fatigue expression appearing in the face information is greater than a preset frequency, wherein the fatigue expression comprises at least one of the following face expressions: blinking, nodding, head shaking, head drop and yawn.

15. The device of claim 9, the one or more processors are further configured to perform the one or more computer readable program codes to perform:
generating a driving behavior evaluation table corresponding to the driving behavior according to a preset evaluation rule; and
uploading the driving behavior evaluation table to a server.

16. The device of claim 15, the one or more processors are further configured to perform the one or more computer readable program codes to perform:
initializing a driving behavior evaluation table, and setting an initial evaluation value of an evaluation item in the driving behavior evaluation table, wherein the driving behavior evaluation table comprises the evaluation item and the evaluation value corresponding to the evaluation item; and
when determining that the driving behavior is the dangerous driving behavior, updating the initial evaluation value of the evaluation item corresponding to the driving behavior according to a preset evaluation rule to obtain an updated driving behavior evaluation table.
